(19) United States
(12) Patent Application Publication
(10) Pub. No.: US 2010/0118676 A1
(43) Pub. Date: May 13, 2010

(54) OPTICAL DISC DRIVE WITH DELAYED LAYER JUMP

(75) Inventor: Omar Shareef Malik, Stirling (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/593,422

(22) PCT Filed: Apr. 1, 2008
(86) PCT No.: PCT/IB2008/051207

§ 371 Date: Sep. 28, 2009

(30) Foreign Application Priority Data
Apr. 5, 2007 (EP) 07105702.0

(51) Int. Cl. G11B 7/00

(52) U.S. Cl. 369/53.22; 369/112.23; G9B/7

(57) ABSTRACT

An optical disc drive (1), capable of handling optical discs (2) with at least two storage layers (61, 62), comprises an axially displaceable objective lens (34) and a focus actuator (52) for controlling the axial position of the objective lens; a control circuit (90) for generating actuator control signals (SQF) for the focus actuator; and a threshold source (98) for providing a threshold level (VT) lower than a supply voltage (Vs) for the focus actuator. The control circuit (90) monitors a focus disturbance signal and delays a layer jump if the absolute value of the focus disturbance signal is too high. Particularly, the control circuit compares the absolute value of the disturbance signals with said threshold level and, if this absolute value is higher than said threshold level, inhibits (83) the layer jump until the absolute value of the disturbance signals becomes lower than said threshold level.

### FIELD OF THE INVENTION

The present invention relates in general to the field of optical recording. More particularly, the present invention relates to an optical disc drive apparatus for handling multiple layer optical discs; hereinafter, such disc drive apparatus will also be indicated as “optical disc drive”. The present invention relates in general to any type of disc, but particularly to DVD and BD.

### BACKGROUND OF THE INVENTION

As is commonly known, an optical storage disc comprises at least one track, either in the form of a continuous spiral or in the form of multiple concentric circles, of storage space where information may be stored in the form of a data pattern. Optical discs may be read-only type, where information is recorded during manufacturing, which information can only be read by a user. The optical storage disc may also be a writable type, where information may be stored by a user.

For writing information in the storage space of the optical storage disc, or for reading information from the disc, an optical disc drive comprises, on the one hand, rotating means for receiving and rotating an optical disc, and on the other hand optical scanning means for generating an optical beam, typically a laser beam, and for scanning the storage track with said laser beam. Since the technology of optical discs in general, the way in which information can be stored in an optical disc, and the way in which optical data can be read from an optical disc, is commonly known, it is not necessary here to describe this technology in more detail.

The optical scanning means comprise an objective lens for focusing the light beam in a focal spot on the disc. During operation, the focal spot should remain aligned with a track or should be capable of being displaced from a current track to a new track. To this end, at least the objective lens is mounted radially displaceable, and the optical disc drive comprises radial actuator means for controlling the radial position of the objective lens. Further, the light beam should remain focused on the disc. To this end, the objective lens is arranged axially displaceable, and the optical disc drive comprises focal actuator means for controlling the axial position of the objective lens.

The information track is physically arranged in a storage layer of the disc. Apart from discs having only one storage layer, there have been developed discs having two storage layers above each other. It is noted that a disc may even have three or more storage layers, but the present invention will hereinafter be explained for the case of a double-layer disc.

### SUMMARY OF THE INVENTION

When writing information to the disc, the information is usually written consecutively in one track. However, it may be that this track does not have sufficient space to continue writing. When the available space is full, a jump must be made to another location, either in the same track or in the track of a different layer. In the following, a jump to a location in a different layer will be indicated as a “layer jump”.

Likewise, it is possible that a layer jump must be made when reading, because the user gives a command that requires reading information from a layer different from the current one.

Executing a layer jump requires displacing the objective lens over a relatively large distance and, in order to do this fast, it requires a relatively large focus actuator drive signal. A common supply voltage for the actuators is 12 V. However, a recent development is towards lower voltages, for instance 5 V. Now a problem may occur in a situation when there is some disturbance on the focus actuator drive signal. If the disturbance has a relatively high value, it may be that there is insufficient margin for the actuator drive signal. The actuator signal may clip, and the jump may be not correctly performed.

An object of the present invention is to reduce this problem.

According to the present invention, disturbances on the focus actuator drive signal are monitored and compared to a threshold. If the disturbance level is too high, layer jumps are inhibited.

Further advantageous elaborations are mentioned in the dependent claims.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 schematically illustrates an optical disc drive;

FIG. 2 is a graph showing actuator signals as a function of time;

FIG. 3 is a graph showing actuator signals as a function of time, together with a threshold level;

FIG. 4 is a flow diagram illustrating steps taken in accordance with the present invention.

### DETAILED DESCRIPTION OF THE EMBODIMENTS

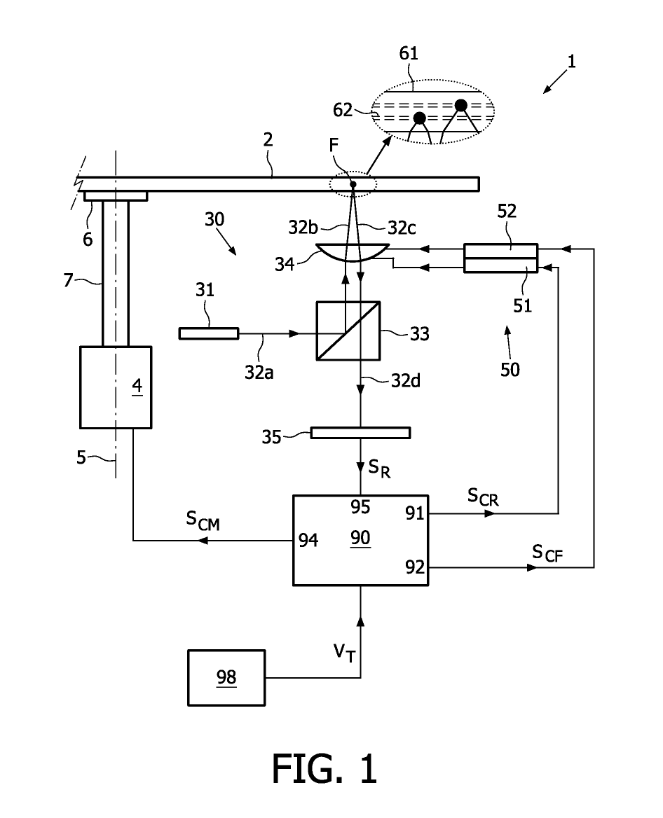

FIG. 1 schematically illustrates an optical disc drive apparatus 1, suitable for storing information on or reading information from an optical disc 2, typically a DVD or a BD. For rotating the disc 2, the disc drive apparatus 1 comprises a motor 4 fixed to a frame (not shown for sake of simplicity), defining a rotation axis 5. For receiving and holding the disc 2, the disc drive apparatus 1 may comprise a turntable or clamping hub 6, which in the case of a spindle motor 4 is mounted on the spindle axle 7 of the motor 4.

The disc drive apparatus 1 further comprises an optical system 30 for scanning tracks (not shown) of the disc 2 by an optical beam. More specifically, in the exemplary arrangement illustrated in FIG. 1, the optical system 30 comprises a light beam generating means 31, typically a laser such as a laser diode, arranged to generate a light beam 32. In the following, different sections of the optical path of light beam 32 will be indicated by a character a, b, c, etc added to the reference numeral 32.

The light beam 32 passes a beam splitter 33 and an objective lens 34 to reach (beam 32b) the disc 2. The light beam 32b reflects from the disc 2 (reflected light beam 32c) and passes the objective lens 34 and the beam splitter 33 (beam 32d) to reach an optical detector 35.

The objective lens 34 is designed to focus the light beam 32b in a focal spot F on a recording layer of the disc 2, which spot F normally is circular. In an enlargement, the figure shows that the disc 2 comprises two recording layers 61, 62 arranged in parallel.

The disc drive apparatus 1 further comprises an actuator system 50, which comprises a radial actuator 51 for radially displacing the objective lens 34 with respect to the disc 2. Since radial actuators are known per se, while the present invention does not relate to the design and functioning of such radial actuator, it is not necessary here to discuss the design and functioning of a radial actuator in great detail.

For achieving and maintaining a correct focusing on the desired recording layer, said objective lens 34 is mounted axially displaceable, while further the actuator system 50 also comprises a focal actuator 52 arranged for axially displacing the objective lens 34 with respect to the disc 2. Since axial actuators are known per se, while further the design and operation of such axial actuator is no subject of the present invention, it is not necessary here to discuss the design and operation of such focal actuator in great detail.

It is noted that means for supporting the objective lens with respect to an apparatus frame, and means for axially and radially displacing the objective lens, are generally known per se. Since the design and operation of such supporting and displacing means are no subject of the present invention, it is not necessary here to discuss their design and operation in great detail.

It is further noted that the radial actuator 51 and focal actuator 52 may be implemented as one integrated 2D-actuator.

The disc drive apparatus 1 further comprises a control circuit 90 having a first output 91 coupled to a control input of the radial actuator 51, having a second output 92 connected to a control input of the focal actuator 52, and having a third output 94 coupled to a control input of the motor 4. The control circuit 90 is designed to generate at its first output 91 a control signal S_{CR} for controlling the radial actuator 51, to generate at its second control output 92 a control signal S_{CF} for controlling the focal actuator 52, and to generate at its third output 93 a control signal S_{CM} for controlling the motor 4.

The control circuit 90 further has a read signal input 95 for receiving a read signal S_{R} from the optical detector 35.

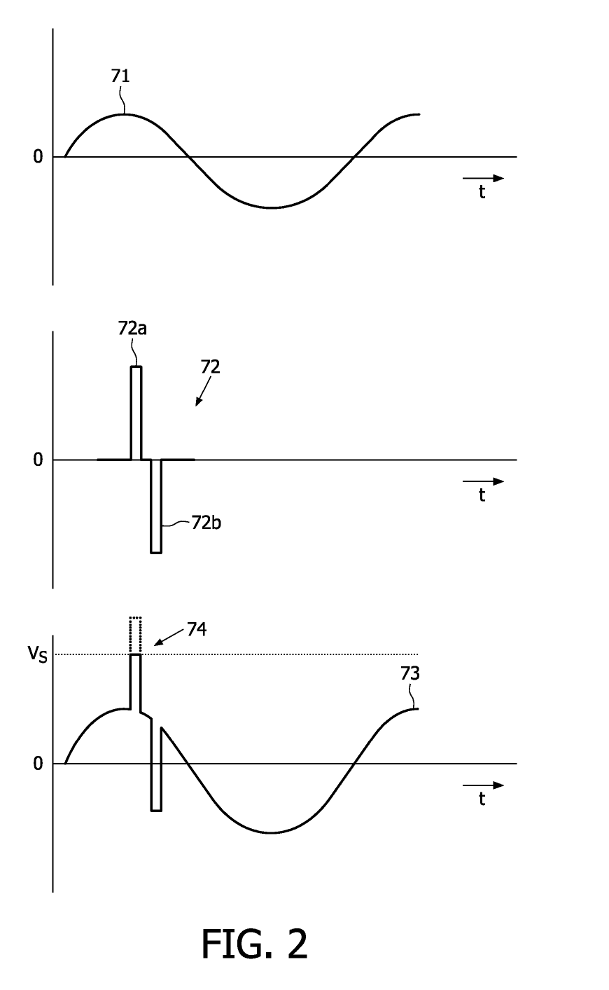

FIG. 2 is a graph illustrating a problem associated with performing a layer jump; the horizontal axis represents time, the vertical axis represents signal level (volt). The focal actuator control signal S_{CF} is a summation of two contributions. A first contribution, shown as curve 71, is typically a sine-shaped signal and is required to compensate disturbances in the axial direction such as to keep the beam focused on the recording layer. A second contribution, shown as a block signal 72, is required to perform a layer jump. This second contribution, which will be indicated as a jump control signal, comprises two signal portions 72a and 72b, wherein the first signal portion 72a results in an acceleration of the objective lens while the second signal portion 72b, having opposite sign as compared to the first signal portion 72a, results in a deceleration of the objective lens.

FIG. 2 also shows the summation of said two signals (curve 73). FIG. 2 also shows a supply voltage Vs from which the actuators are supplied with power. Now, as illustrated at 74, it can be seen that a problem exists in that the summation of said two contributions (shown in a dotted line) can be larger than the supply voltage Vs. In that case, the actual actuator control signal (given by the solid line) will be less than the intended actuator control signal (given by the dotted line), and the layer jump will not be accurate.

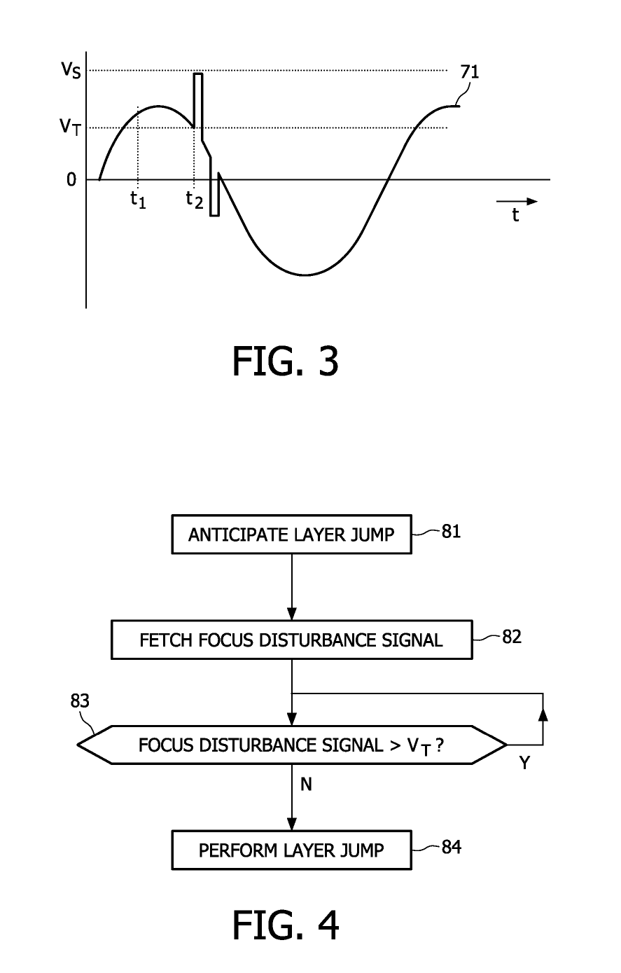

FIG. 3 is a graph similar to FIG. 2, now illustrating the solution proposed by the present invention. Apart from the disturbance control signal 71 and the jump control signal 72, the figure shows a threshold level V_{T} lower than the supply voltage Vs, which is provided to the control circuit 90 by a threshold source 98. If the absolute value of the disturbance control signal 71 is higher than the threshold level V_{T}, the control circuit 90 prevents the jump control signal 72 to be issued. Assume that it is desired that the jump is executed as from time t1, but that the absolute value of the disturbance control signal 71 is higher than the threshold level V_{T} at time t1. In that case, the jump will be postponed until, at time t2, the absolute value of the disturbance control signal 71 becomes lower than the threshold level V_{T}. Thus, there is at all times a margin of Vs-V_{T} for the jump control signal 72.

FIG. 4 is a flow diagram illustrating the steps taken by the control circuit 90 in accordance with the present invention. For this explanation, it is immaterial whether the layer jump is forwards or backwards in the axial direction.

In step 81, the control circuit 90 receives a signal indicating that it should anticipate on performing a layer jump at the next possible occasion.

In step 82, the control circuit 90 reads the focus disturbance signal, and in step 83, the control circuit 90 compares the focus disturbance signal with the threshold level V_{T}.

If it appears that the absolute value of the focus disturbance signal is higher than the threshold level V_{T}, the control circuit 90 returns to step 83. This situation is continued until it appears that the absolute value of the focus disturbance signal is lower than the threshold level V_{T}, in which case the control circuit 90 in step 84 generates the jump control signal to perform the layer jump.

Thus, effectively, a layer jump is delayed until the absolute value of the focus disturbance signal is low enough.

It is noted that the above operation is executed when the control circuit 90 anticipates that a layer jump is to be performed soon, but not necessarily immediately. In that case, it is allowable for the control circuit 90 to wait with issuing the layer jump control signal. However, it is also possible that the timing of layer jump is dictated by external conditions, for instance because the disc drive is reading a movie from a disc where the movie information jumps from one layer to another.

Summarizing, the present invention provides an optical disc drive 1, capable of handling optical discs 2 with at least two storage layers 61, 62, comprising an axially displaceable objective lens 34 and a focus actuator 52 for controlling the axial position of the objective lens;

a control circuit 90 for generating actuator control signals S_{CF} for the focus actuator;

and a threshold source 98 for providing a threshold level V_{T} lower than a supply voltage V_{S} for the focus actuator.

The control circuit 90 monitors a focus disturbance signal and delays a layer jump if the absolute value of the focus disturbance signal is too high.

Particularly, the control circuit compares the absolute value of the disturbance signals with said threshold level and, if this absolute value is higher than said threshold level, inhibits step 83 the layer jump until the absolute value of the disturbance signals becomes lower than said threshold level.

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Method for controlling an optical disc drive (1) capable of handling optical discs (2) with at least two storage layers (61, 62), comprising the steps of monitoring a focus disturbance signal and delaying a layer jump if the absolute value of the focus disturbance signal is too high.

2. Method according to claim 1, for controlling an optical disc drive (1) capable of handling optical discs (2) with at least two storage layers (61, 62), the disc drive comprising an axially displaceable objective lens (34) and a focus actuator (52) for controlling the axial position of the objective lens;
the method comprising the steps of:
defining a threshold level (V_{T}) lower than a supply voltage (V_{S}) for the focus actuator;
receiving a signal indicating an approaching layer jump;
comparing the absolute value of disturbance signals of the focus actuator control signal (S_{CF}) with said threshold level;
if the absolute value of the disturbance signals of the focus actuator control signal is higher than said threshold level, inhibiting (83) the layer jump until the absolute value of the disturbance signals of the focus actuator control signal becomes lower than said threshold level.

3. Optical disc drive (1) capable of handling optical discs (2) with at least two storage layers (61, 62), the disc drive comprising:
an axially displaceable objective lens (34) and a focus actuator (52) for controlling the axial position of the objective lens;
a control circuit (90) for generating actuator control signals (S_{CF}) for the focus actuator;
a threshold source (98) for providing a threshold level (V_{T}) lower than a supply voltage (V_{S}) for the focus actuator;
the control circuit (90) being designed for performing the method of claim 1.
